(19) United States
(12) Patent Application Publication
(10) Pub. No.: US 2023/0329310 A1
(43) Pub. Date: Oct. 19, 2023

(54) APPARATUS FOR THE ASSOCIATION OF LIQUID AND FOODSTUFF ONTO A BASE

(71) Applicant: Picnic Works, Inc., Seattle, WA (US)

(72) Inventors: Brian Michael De Vitis, Seattle, WA (US); Kort Edward Reinecke, Seattle, WA (US)

(73) Assignee: Picnic Works, Inc., Seattle, WA (US)

(21) Appl. No.: 17/753,390

(22) PCT Filed: Sep. 18, 2020
(86) PCT No.: PCT/US20/51617

§ 371 Date: Mar. 1, 2022

(51) Int. Cl. A23P 20/20; A23P 20/18; A23P 20/12; A21C 9/04

(52) U.S. Cl. CPC A23P 20/20; A23P 20/18; A23P 20/12; A21C 9/04

(57) ABSTRACT

This invention relates to an apparatus for assembling food products.

### CROSS-REFERENCES TO RELATED APPLICATIONS

This Application is a continuation-in-part of U.S. application Ser. No. 16/360,279, filed on Mar. 21, 2019, and U.S. application Ser. No. 16/260,487, filed on Mar. 21, 2019, and incorporated herein by reference.

### STATEMENT REGARDING FEDERALLY SPONSORED RESEARCH OR DEVELOPMENT

Not Applicable

### BACKGROUND

The present invention relates to an apparatus and methods for assembling food products. More particularly, the invention relates to an apparatus that manages the movement of a base so that foodstuff and/or liquid may be associated with the base.

The process of associating foodstuff to a base is labor intensive and subject to human error. Consider, for example, assembling a pizza. Once pizza dough has been formed and prepped into the correct size, a specified amount of sauce and bulk ingredients (e.g. mushrooms, olive, pepperoni, green peppers, amongst others) must be applied to the base. A person must apply ingredients one at a time at the desired consistency. This process requires time and precision. There is a need for an apparatus which can apply multiple ingredients simultaneously and with uniform distribution.

Foodstuff may include food items such as meats, vegetables, cheeses, amongst others. Liquids include those food items that have low viscosities (e.g. sauces, dressings, oils), high viscosities (e.g. peanut butter, frosting), and anything in between. A base can be anything on which foodstuff or liquid may be associated (e.g. bread, cake, cookies, pizza dough, a bowl in which to place foodstuff).

### BRIEF DESCRIPTION OF INVENTION

An objective of the invention is to provide an automated apparatus which will rotate to allow foodstuff to be deposited onto a base at the desired density.

Another objective is to provide an apparatus which allows for the interaction between utensils and said base. Additional objectives are to provide an apparatus which allows multiple foodstuff toppings to be applied simultaneously and to reduce the floor space and manual labor required to apply foodstuff toppings to pizza.

### BRIEF DESCRIPTION OF DRAWINGS

Other features and advantages of the present invention will become apparent in the following detailed descriptions of the preferred embodiment with reference to the accompanying drawings:

FIG. 1 shows an embodiment of an apparatus for the association of liquid and foodstuff onto a base;

FIG. 2 shows an embodiment of an apparatus for the association of liquid and foodstuff onto a base;

FIG. 3 shows an embodiment of an apparatus for the association of liquid and foodstuff onto a base;

FIG. 4 shows an embodiment of an apparatus for the association of liquid and foodstuff onto a base.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

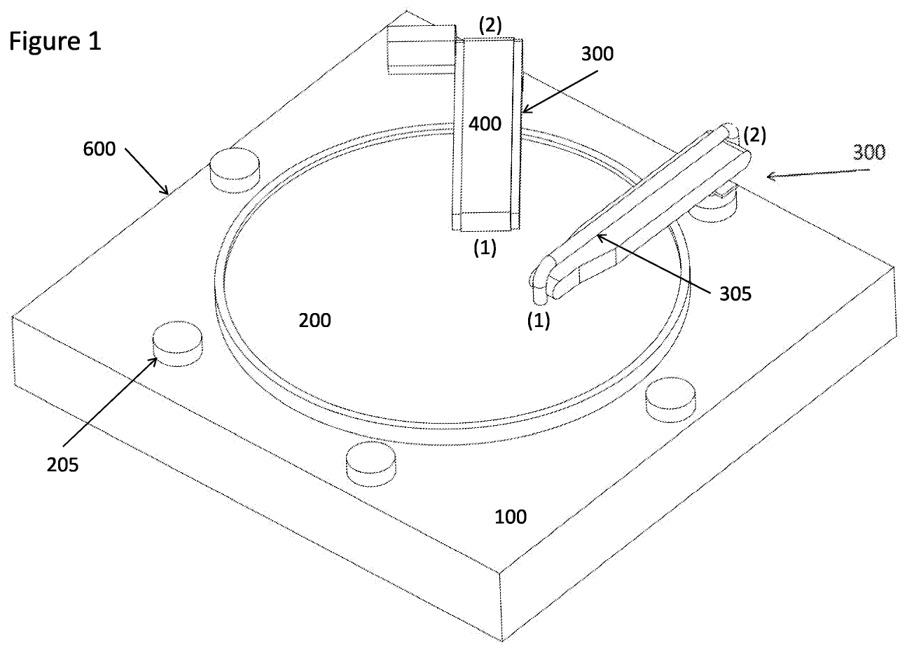

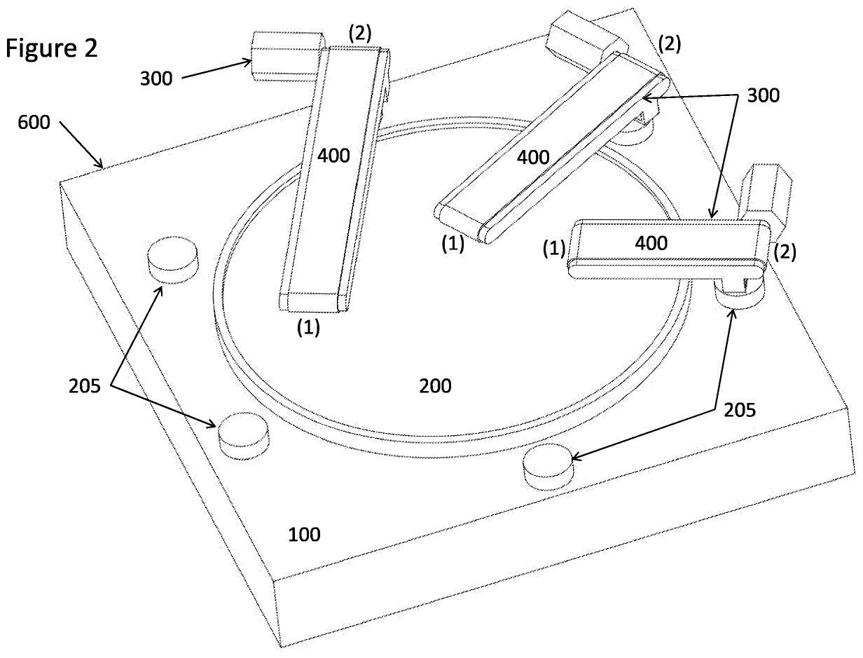

Referring to FIGS. 1 through 4, the invention described herein is an apparatus for the association of liquid and foodstuff onto a base (“apparatus”) 600. The apparatus is comprised of a platform 100 having a turntable 200 and a plurality of arms 300. The turntable 200 is operably attached to the platform 100 so as to allow the turntable 200 to rotate while the platform 100 remains stationary. According to an embodiment, the turntable 200 can be remotely or locally controlled.

According to an embodiment, each of the plurality of arms 300 may be fixed point 205 on the platform 100. According to an embodiment, each of the plurality of arms 300 may be operably attached to the platform 100 so that each arm can independently rotate from its fixed point 205 on the platform 100. Preferably, each fixed point 205 is located outside the area the turntable 200 occupies.

In an embodiment, the plurality of arms 300 are attached to the platform 100, such that at least one arm of the plurality of arms 300 may be interchanged with at least another arm of the plurality of arms 300. In another embodiment, at least one arm from the plurality of arms 300 maybe oriented along a different portion of a base, away from the base, or in concert with at least one other arm in the plurality of arms 300 amongst others. In an embodiment, the plurality of arms 300 may be of varying lengths. In another embodiment, the arms 300 are of the same length.

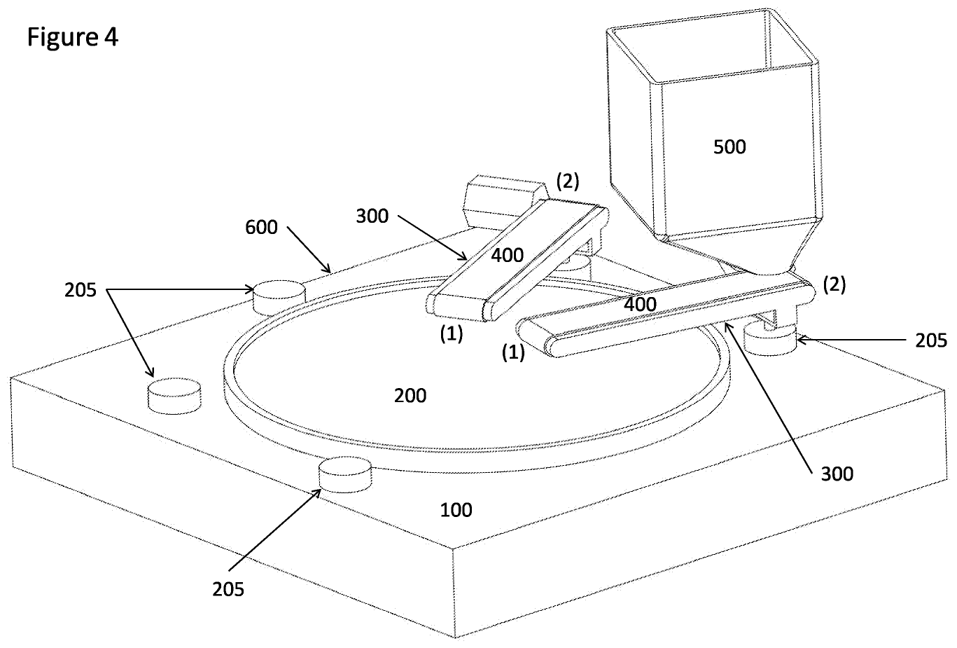

Each of the plurality of arms 300 has a near end (1) and a far end (2). The near end (1) associates liquid or foodstuff with a base wherein the base is located on the turntable 200. In an embodiment, at least one arm 300 is a conveyor belt 400. The conveyor belt 400 allows foodstuff to be delivered to the base on the turntable 200. The conveyor belt 400 is comprised of at least two pulleys, and an endless loop of carrying medium; the endless loop is rotated by pulleys, gears, belts or other similar driving mechanisms. When activated, at least one of the pulleys is powered and causes the belt to rotate. In an embodiment the conveyor belt 400 is configured so that the rotational speed is adjustable allowing a desired amount of foodstuff to be associated with a base at a planned on the base. Referring to FIG. 4, in an embodiment at least one arm 300 is comprised of a conveyor belt 400 is operably connected to a foodstuff source 500.

In an embodiment, foodstuff may be distributed onto a base as the base is being rotated on the turntable 200. In an embodiment, each arm 300 may pivot from its fixed point 205 such that the near end (1) of the arm 300 can distribute foodstuff in a desired pattern on the base.

Referring to FIG. 1, in another embodiment, at least one arm 300 is further comprised of a liquid dispensing tube 305. According to an embodiment, the tube 305 is fluidly connected to a liquid supply. The dispensing location of the tube 305 is located at the near end (1) of the arm 300 so that liquid is distributed from the tube 305 onto a base. According to an embodiment, at least one arm 300 has the capability to expand and retract such that the tube 305 may be positioned at any point along a radius of a base.

In an embodiment, at least one of the plurality of arms 300 may be molded so that liquid may run through the arm. In another embodiment, at least one of the plurality of arms 300 is operably attached to a tube 305 allowing the arm to associate liquid onto the base. Hereinafter, each of these mechanisms and similar mechanisms allowing liquid to flow from or through an arm 300 will be referred to as tube(s) 305.

According to an embodiment, a tube 305 maybe connected to a valve such that a defined amount of liquid is associated with a base. In another embodiment the tube 305 is connected to a liquid supply which utilizes a pump for regulation.

In an embodiment, the turntable 200 rotates at a speed which allows for the tube 305 to deposit a determined amount of liquid onto a base at a planned location.

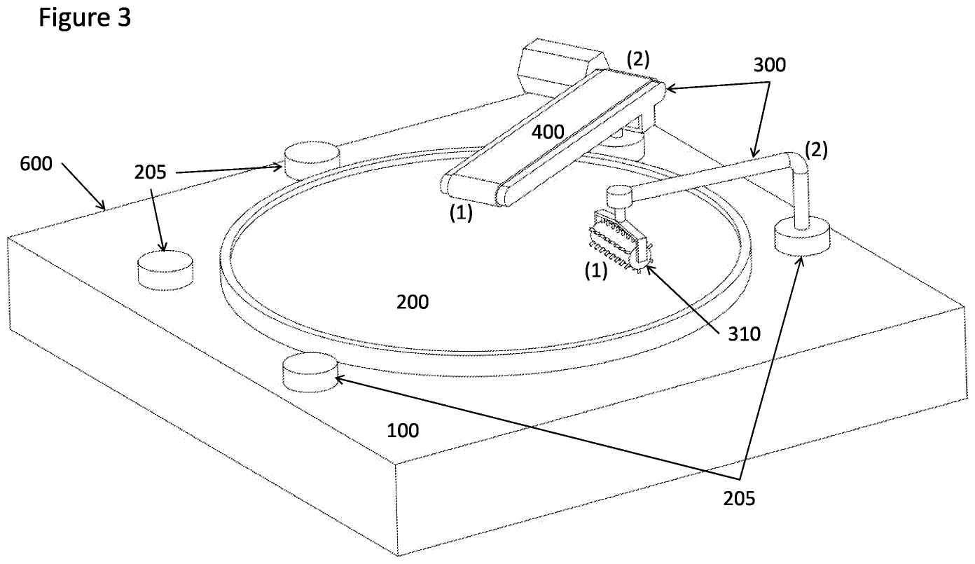

Referring to FIG. 3, according to an embodiment, at least one of the plurality of arms 300 may comprise a utensil 310. The utensil 310 is located on the near end (1) of the arm, such that the arm 300 allows the utensil 310 to interact with the base on the turntable 200. An example may be, but is not limited to, a pizza slicer or a dough docker. In an embodiment, the at least one arm of plurality of arms 300 having a utensil 310 may elongate or retract so that the utensil 310 may interact with more than one location on the base.

As will be appreciated by one skilled in the art, aspects of the software may be embodied as a system, method, or computer product. Accordingly, aspects of the software may take the form of an entirely hardware embodiment, entirely software embodiment (including firmware, resident software, micro-code, etc.), or an embodiment combining software and hardware aspects. Further aspects of the software may take the form of a computer program embodied in one or more readable medium having computer readable program code/instructions thereon. Program code embodied on computer-readable medium may be transmitted using any appropriate medium, including but not limited to wireless, wireline, optical fiber cable, RF, etc., or any suitable combination of the foregoing. The computer code may be executed entirely on a user's computer; partly on the user's computer; as a standalone software package; a cloud service; partly on the user's computer and partly on a remote computer; or entirely on a remote computer, remote or cloud-based server.

In an embodiment, each arm 300 operates independently. According to an embodiment, the turntable 200 and the arms 300 communicate remotely with software that receives input of a desired amount of liquid or foodstuff from a user. In an embodiment each arm 300 pivots to associate liquid and/or foodstuff with the base. In an embodiment, the arms 300 communicate with each other to coordinate position information so that each of the plurality of arms 300 can distribute liquid and/or foodstuff to a base at a desired location on the base.

An exemplary system may be comprised of a plurality of apparatus 600. In an exemplary method, of pizza making, crust may be placed on a first apparatus 600a where liquid is associated with the crust and then moved to a second apparatus 600b where food stuff is associated with the crust. The crust can be moved from the first apparatus 600a to the second apparatus 600b by the user or by a robotic arm, pulley system or some automated system.

In an exemplary method of pizza making, dough is placed on the turntable 200. An arm 300, having a utensil 310 interacts with the dough until it is at a desired consistency. Here, the utensil 310 maybe rolling pin. As the ball of dough compresses and spreads, the turntable 200 will rotate at a rate allowing the rolling pin to continually interact with the edge of the dough and regular intervals. The rolling pin may retract towards the outer edge of the turntable 200 to allow continued interaction with the edge of the dough. The turntable 200 will continue to rotate as pizza sauce and foodstuff (e.g. cheese, pepper, onions) are associated with the dough.

One skilled in the art will recognize the variety of alternative possibilities for the individual elements, and their arrangements, described above, while still falling within the spirit of the invention. Further, while the above describes several embodiments of the invention used primarily in connection with making pizza, those skilled in the art will appreciate that there are a number of alternatives that still fall within the spirit of our invention. Thus, it is to be understood that the invention is not limited to the embodiments described above, and that in light of the present disclosure, various other embodiments should be apparent to persons skilled in the art. Accordingly, it is intended that the invention not be limited to the specific illustrative embodiments.

1. An apparatus for associating liquid to a base comprised of a platform wherein the platform is operably connected to a turntable and a plurality of arms; wherein, the turntable rotates independently of the platform and the plurality of arms; wherein each arm is fixed on the platform; wherein each of the plurality of arms acts independently of each other; wherein at least one arm has a near end and a far end; wherein the far end is fluidly connected to a liquid supply; wherein the near end of the arm associates liquid with a base.

2. The apparatus of claim 1 where at least one arm of the plurality of arms may elongate or retract.

3. The apparatus of claim 1 where at least one arm may be a kitchen utensil.

4. The apparatus of claim 1 where each of the plurality of arms coordinates it position with every other arm.

5. The apparatus of claim 1 where liquid is associated with a base at a desired location.

6. An apparatus for associating foodstuff to a base comprised of a platform wherein the platform is operably connected to a turntable and a plurality of arms; wherein, the turntable rotates independently of the platform and the plurality of arms; wherein each arm is fixed on the platform; wherein each of the plurality of arms acts independently of each other; wherein at least one arm is a conveyor belt having a near end and a far end; wherein the far end is operably connected with a foodstuff source; wherein foodstuff is delivered from the foodstuff source to the conveyor belt; wherein the near end of the arm associates foodstuff onto a base.

7. The apparatus of claim 6 where at least one arm of the plurality of arms may elongate or retract.

8. The apparatus of claim 6 where at least one arm may be a kitchen utensil.

9. The apparatus of claim 6 where each of the plurality of arms coordinates it positions with each other arm.

10. The apparatus of claim 6 where foodstuff is associated with a base at a desired location

11. An apparatus for associating liquid and foodstuff to a base comprised of a platform wherein the platform is operably connected to a turntable and a plurality of arms; wherein, the turntable rotates independently of the platform and the plurality of arms; wherein each arm is fixed on the platform; wherein each of the plurality of arms acts independently of each other; wherein at least one arm has a near end and a far end; wherein the far end is fluidly connected to a liquid supply; wherein the near end of the arm associates liquid with a base; wherein at least one arm is a conveyor belt having a near end and a far end; wherein the far end is operably connected with a foodstuff source; wherein foodstuff is delivered from the foodstuff source to the conveyor belt; wherein the near end of the arm associates foodstuff onto a base.

12. The apparatus of claim 11 where at least one arm of the plurality of arms may elongate or retract.

13. The apparatus of claim 11 where at least one arm may be a kitchen utensil.

14. The apparatus of claim 11 where each of the plurality of arms coordinates it positions with each other arm.

15. The apparatus of claim 11 where liquid and foodstuff is associated with a base at a desired location

16. A method to assemble a pizza using an apparatus for associating liquid and foodstuff to a base where the apparatus is:
comprised of a platform wherein the platform is operably connected to a turntable and a plurality of arms; wherein, the turntable rotates independently of the platform and the plurality of arms; wherein each arm is fixed on the platform; wherein each of the plurality of arms acts independently of each other; wherein at least one arm has a near end and a far end; wherein the far end is fluidly connected to a liquid supply; wherein the near end of the arm associates liquid with a base; wherein at least one arm is a conveyor belt having a near end and a far end; wherein the far end is operably connected with a foodstuff source; wherein foodstuff is delivered from the foodstuff source to the conveyor belt; wherein the near end of the arm associates foodstuff onto a base;
wherein the method comprises associating either liquid or foodstuff to a base.
